(19) United States
(12) Patent Application Publication
(10) Pub. No.: US 2021/0238075 A1
(43) Pub. Date: Aug. 5, 2021

(54) METHOD AND APPARATUS FOR REALIZING HETEROTROPHIC AND AUTOTROPHIC COUPLING ADVANCED NITROGEN REMOVAL AND SIMULTANEOUS SLUDGE REDUCTION AOA-SBR

(71) Applicant: BEIJING UNIVERSITY OF TECHNOLOGY, Beijing (CN)

(72) Inventors: Yongzhen Peng, Beijing (CN); Jinjinie Liu, Beijing (CN); Shengjie Qiu, Beijing (CN); Yang Xia, Beijing (CN); Qiong Zhang, Beijing (CN)

(21) Appl. No.: 17/041,374

(22) PCT Filed: Apr. 2, 2020
(86) PCT No.: PCT/CN2020/082894

§ 371 Date: Sep. 24, 2020

(30) Foreign Application Priority Data
Apr. 2, 2019 (CN) 201910259853.X

(51) Int. Cl. C02F 9/00

(52) U.S. Cl. CPC C02F 9/00; C02F 2209/02; C02F 3/307; C02F 2209/22; C02F 2209/06

(57) ABSTRACT

A method for realizing heterotrophic and autotrophic coupling advanced nitrogen removal and simultaneous sludge reduction in an anaerobic-aerobic-anoxic sequencing batch reactor (AOA-SBR) is disclosed. Municipal sewage and sludge fermentation mixture is allowed to simultaneously enter into the AOA-SBR; in the anaerobic stage, the organic matter in the sewage and sludge fermentation mixture is converted into polyhydroxyalkanoates (PHA) and stored in the body; in the aerobic stage, the dissolved oxygen (DO) at 0.5˜1 mg/L is maintained by a real-time control, the aeration time is set for 1˜3 h, and when the mass concentration ratio of NO₂⁻—N to NH₄⁺—N is in a range from 1.5 to 2.0, the aeration is stopped, that is, ammonia-nitrogen is partially converted into nitrite-nitrogen through short-cut nitrification; in the anoxic stage, the remaining ammonia-nitrogen and nitrite-nitrogen undergo anaerobic ammonia oxidation (anammox), and meanwhile the remaining nitrite-nitrogen and nitrate-nitrogen generated by anammox is reduced by denitrifying bacteria to nitrogen to achieve advanced nitrogen removal. A related apparatus is also provided, which simultaneously realizes advanced nitrogen removal of sewage and reduction of sludge.

### TECHNICAL FIELD

The invention relates to an optimization control of a method and an apparatus for realizing heterotrophic and autotrophic coupling advanced nitrogen removal and simultaneous sludge reduction in an anaerobic-aerobic-anoxic sequencing batch reactor (AOA-SBR), which belongs to the field of municipal sewage treatment and sludge biochemical treatment. The invention is suitable for enhancing advanced nitrogen removal of low C/N ratio municipal sewage.

### BACKGROUND

Biological nitrogen removal technology is widely used in municipal sewage treatment plants. However, the application of traditional biological nitrogen removal processes is limited by the insufficient carbon source of municipal sewage. At the same time, the sewage treatment plant inevitably generates a large amount of excess sludge, and the treatment and disposal of the excess sludge is also a great difficulty. The excess sludge is a substance generated in the biological treatment process of sewage, and the main organic components are protein, carbohydrate and fat. The anaerobic fermentation technology of excess sludge can generate a large amount of short-chain fatty acids, which can be used as a high-quality carbon source in the biological denitrification process, and simultaneously realize sludge reduction treatment. Exploiting the internal carbon source of the excess sludge can use the fermentation liquid after separating the fermentation liquid from the sludge, or directly utilize the sludge fermentation mixture. Considering practical problems such as operation cost and the like, the cost of using only supernatant of the sludge fermentation is too high, and the excess sludge fermentation mixture can be selected.

Nitrifying bacteria are a kind of chemotroph bacteria, mainly comprising ammonia oxidizing bacteria (AOB) and nitrite oxidizing bacteria (NOB), converting ammonia-nitrogen into nitrite-nitrogen and converting nitrite-nitrogen into nitrate-nitrogen respectively, and playing an irreplaceable role in the biological denitrification process of sewage. Short-cut nitrogen removal technology is to control the nitrification process in the ammonia oxidation stage, and then directly perform denitrification, thereby achieving the purpose of energy saving and consumption reduction. Short-cut nitrification is the key to short-cut nitrogen removal technology, and the key to short-cut nitrification is to realize enrichment of AOB and inhibition and elutriation of NOB.

The method and the apparatus for realizing heterotrophic and autotrophic coupling advanced nitrogen removal and simultaneous sludge reduction in AOA-SBR, take excess sludge and municipal sewage as research objects, utilize sludge fermentation product to different inhibition capacity of nitrifying bacteria (AOB and NOB) to achieve the effect of elutriation of NOB, through the realization of partial short-cut nitrification anaerobic ammonia oxidation, i.e. anammox, and anoxic denitrification to achieve advanced nitrogen removal, which improves the total nitrogen removal rate of the system. Using the sludge discharged from a sewage plant as a carbon source improves the efficiency of nitrogen removal and meanwhile saves the cost of additional carbon sources; the use of sludge fermentation mixture omits the process of separating sludge and fermentation liquid, saves costs, and meanwhile realizes sludge reduction treatment.

### SUMMARY OF THE INVENTION

In view of the drawback of the prior art, the present invention provides a method and an apparatus for realizing heterotrophic and autotrophic coupling advanced nitrogen removal and simultaneous sludge reduction in AOA-SBR. The excess sludge fermentation mixture is pumped into a sequencing batch reactor SBR for treating sewage with a low C/N ratio, the addition of sludge fermentation product enables the activity of nitrite oxidizing bacteria to be inhibited, so that ammonia-nitrogen in an aerobic zone is partially converted into nitrite-nitrogen, and then performs anoxic stirring. The remaining ammonia-nitrogen and nitrite-nitrogen undergo anammox, and meanwhile denitrifying bacteria reduce the remaining nitrite-nitrogen and nitrate-nitrogen generated by anammox to nitrogen to complete advanced nitrogen removal.

The present invention is realized by the following technical solutions:

(1) the excess sludge fermentation tank (2) is a semi-continuous reactor, and an inoculated sludge is sludge discharged from a secondary sedimentation tank of a municipal sewage treatment plant, a sludge retention time (SRT) is 6-20 days, and pH is controlled to be 9-10; according to SRT, an excess sludge fermentation mixture is discharged to a fermentation mixture storage tank (9) every day and an equal volume of fresh excess sludge is added to the excess sludge fermentation tank (2);

(2) start-up of a sequencing batch reactor SBR: a complete nitrification sludge is used as inoculation sludge to be injected into the sequencing batch reactor SBR (13), and actual municipal sewage is used as raw water to be injected into a sewage tank (8) and pumped into the sequencing batch reactor SBR (13) through the third peristaltic pump (10), and meanwhile the sludge fermentation mixture is pumped into the sequencing batch reactor SBR (13) through the second peristaltic pump (11), and it runs for 2-4 cycles every day, a drainage ratio is maintained at 50-80%, and each cycle includes influent, anaerobic stirring, aeration, anoxic stirring, settle and drainage.

Sequencing Batch Reactor SBR:

I. influent: an amount for sewage feeding is set at ½˜⅘ of SBR effective volume, and an amount for the fermentation mixture feeding is 1/50˜ 1/10 of the sewage feeding volume, both are controlled by a time-controlled switch, after SBR is started, the sewage in the sewage tank (8) is allowed to enter the sequencing batch reactor SBR (13) through the third peristaltic pump (10), during the influent, the fermentation mixture in the excess sludge fermentation tank (2) is allowed to enter SBR (13) through the second peristaltic pump (11);

II. anaerobic stirring: after completion of the influent, it enters a stage of anaerobic stirring, and a stirring time is set for 2˜3.5 h;

III. aeration: an air compressor (16) is started to provide oxygen to the sequencing batch reactor SBR (13) and ammonia-nitrogen is converted into oxidized nitrogen; dissolved oxygen DO of 0.5˜1 mg/L is maintained by a real-time control device, an aeration time is set for 1˜3 h,

IV. anoxic stirring: a stirring time of anoxic stirring is set for 2˜5 h;

VI. settle and drainage: a sedimentation time for settle is set for 1˜2 h, the drainage is performed after a separation of sludge and water, wherein a drainage ratio is 50%˜80%.

From the above, the present invention provides a method and an apparatus for realizing heterotrophic and autotrophic coupling advanced nitrogen removal and simultaneous sludge reduction in AOA-SBR. Excess sludge and municipal sewage are used as research objects. The sludge fermentation product has different inhibition activity on nitrifying bacteria (ammonia oxidizing bacteria AOB and nitrite oxidizing bacteria NOB) (the inhibition of NOB is stronger), to achieve a higher accumulation rate of nitrite; the purpose of low C/N ratio advanced nitrogen removal of sewage can be realized through anammox and denitrification. Using the sludge discharged from a sewage plant as a carbon source improves the efficiency of nitrogen removal and meanwhile saves the cost of external carbon sources; the use of sludge fermentation mixture omits the process of separating sludge and fermentation liquid, saves costs, and meanwhile realizes sludge reduction treatment.

### BRIEF DESCRIPTION OF THE DRAWINGS

FIG. 1 is a schematic structural diagram of the apparatus of the present invention.

Reference numerals in FIG. 1:

1—first peristaltic pump; 2—excess sludge fermentation tank; 3—first agitator; 4—temperature controller; 5—first pH controller; 6—process controller; 7—computer; 8—sewage tank; 9—fermentation mixture storage tank; 10—third peristaltic pump; 11—second peristaltic pump; 12—first dissolved oxygen controller; 13—sequencing batch reactor SBR; 14—second pH controller; 15—second agitator; 16—air compressor;

FIG. 2 is an operation mode of a sequencing batch reactor SBR.

### DETAILED DESCRIPTION

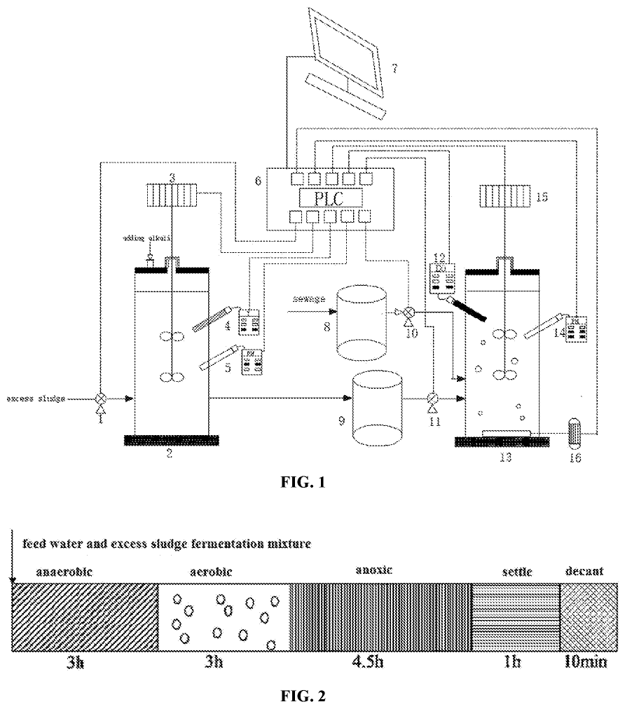

The present invention will be further described in conjunction with the accompanying drawings and examples. As shown in FIG. 1, the present invention comprises an excess sludge fermentation tank, a fermentation mixture storage tank, a sewage tank and a sequencing batch reactor SBR. The effective volumes of the above four devices are 5L, 3L, 30L and 12L respectively, wherein the excess sludge fermentation tank, the fermentation mixture storage tank and the sequencing batch reactor SBR are made of plexiglass.

The apparatus comprises an excess sludge fermentation tank (2) into which excess sludge is pumped through a first peristaltic pump (1), wherein the excess sludge fermentation tank (2) is internally equipped with a first agitator (3), a temperature controller (4) and a first pH controller (5); the excess sludge fermentation tank (2) is connected to a fermentation mixture storage tank (9), and the fermentation mixture storage tank (9) is connected to a sequencing batch reactor SBR (13) through a second peristaltic pump (11); a sewage tank (8) is connected to the sequencing batch reactor SBR (13) through a third peristaltic pump (10); a second agitator (15), an first dissolved oxygen controller (12) and a second pH controller (14) are installed in the sequencing batch reactor SBR (13); an aeration head in the sequencing batch reactor SBR (13) is connected to an air compressor (16); in addition, a process controller (6) connected to a computer (7) is provided for controlling the first peristaltic pump (1), the second peristaltic pump (11), the third peristaltic pump (10), the first agitator (3), the second agitator (15), the temperature controller (4), the first pH controller (5), the second pH controller (14) and the air compressor (16)

The municipal sewage used in the specific example was taken from a septic tank in a residential area in Beijing, in which the chemical oxygen demand COD was 180˜200 mg/L, the concentration of NH₄⁺—N was 60˜70 mg/L, and the C/N ratio is 2˜4, and the self-carbon source cannot meet the purpose of advanced nitrogen removal.

The specific implementation process is as follows:

The excess sludge fermentation tank is a semi-continuous reactor, the inoculated MLSS is 7500˜8000 mg/L, the sludge retention time (SRT) is 6 days, the pH is controlled to be 10±0.2, and the temperature is at 30±2° C. According to SRT, 833 mL of excess sludge fermentation mixture is discharged to the fermentation mixture storage tank every day, and 833 mL of fresh excess sludge is added to the excess sludge fermentation tank. The main indicators of the sludge fermentation mixture are as follows: the MLSS of sludge fermentation product is 4500˜5500 mg/L, SCOD is 3380±420 mg/L, SCFAs is 1221±40 mg COD/L, and NH₄⁺—N is 198 ±20 mg/L.

Start-Up of Sequencing Batch Reactor SBR

a complete nitrification sludge is used as inoculation sludge to be injected into the sequencing batch reactor SBR (13), and actual municipal sewage is used as raw water to be injected into a sewage tank (8) and pumped into the sequencing batch reactor SBR (13) through the third peristaltic pump (10), and meanwhile the sludge fermentation mixture is pumped into the sequencing batch reactor SBR (13) through the second peristaltic pump (11), and it runs for 2˜4 cycles every day, a drainage ratio is maintained at 50-80%, and each cycle includes influent, anaerobic stirring, aeration, anoxic stirring, settle and drainage

Sequencing Batch Reactor SBR

I. influent: an amount for sewage feeding is 54% of SBR effective volume, that is, 6.5L and an amount for the fermentation mixture feeding is 1/18.6 of the sewage feeding volume, that is, 350 ml, both are controlled by a time-controlled switch, after SBR is started, the sewage in the sewage tank is allowed to enter the sequencing batch reactor SBR through the third peristaltic pump (i.e. inlet pump), during the sewage feeding, the fermentation mixture in the excess sludge fermentation tank is allowed to enter SBR through the second peristaltic pump;

II. anaerobic stirring: after completion of the influent, it enters a stage of anaerobic stirring, and a stirring time is set for 3 h; the rich carbon source in the fermentation mixture and sewage is stored as a large amount of PHA;

III. aeration: the dissolved oxygen DO at 0.5˜1 mg/L is maintained by a real-time control device, the pH is monitored, and the aeration time is set for 3 h, NH₄⁺—N reacts short-cut nitrification under the combined action of real-time control and sludge fermentation addition, when the mass concentration ratio of NO₂⁻—N to NH₄⁺—N is 1.5, the aeration is stopped;

IV. anoxic stirring: the stirring time of anoxic stirring is set for 4.5 h, anammox of the remaining ammonia-nitrogen and nitrite-nitrogen will take place in the anoxic zone, and meanwhile denitrification will be carried out, and the remaining nitrite-nitrogen and nitrate-nitrogen generated by anammox are reduced to nitrogen;

VI. settle and drainage: the sedimentation time for settle and drainage is set for 1h, water is discharged into the intermediate water tank after separating sludge and water, wherein the drainage ratio is 57%.

The experimental results show that after the operation is stable, the COD concentration in the effluent is 30˜43 mg/L, the concentration of N₄⁺—N is 0.2˜2.5 mg/L, the accumulation rate of nitrate-nitrogen can reach more than 99%, and the TN removal rate is 85˜90%.

1. An apparatus for realizing heterotrophic and autotrophic coupling advanced nitrogen removal and simultaneous sludge reduction in AOA-SBR, characterized in that, the apparatus comprises an excess sludge fermentation tank into which excess sludge is pumped through a first peristaltic pump, wherein the excess sludge fermentation tank is internally equipped with a first agitator, a temperature controller and a first pH controller; the excess sludge fermentation tank is connected to a fermentation mixture storage tank, and the fermentation mixture storage tank is connected to a sequencing batch reactor SBR through a second peristaltic pump; a sewage tank is connected to the sequencing batch reactor SBR through a third peristaltic pump; a second agitator, a first dissolved oxygen controller and a second pH controller are installed in the sequencing batch reactor SBR; an aeration head in the sequencing batch reactor SBR is connected to an air compressor; in addition, a process controller connected to a computer is provided for controlling the first peristaltic pump, the second peristaltic pump, the third peristaltic pump, the first agitator, the second agitator, the temperature controller, the first pH controller, the second pH controller and the air compressor.

2. A method for applying the apparatus of claim 1, characterized in that, the method comprises the following steps of:
(1) start-up of an excess sludge fermentation tank
the excess sludge fermentation tank is a semi-continuous reactor, and an inoculated sludge is sludge discharged from a secondary sedimentation tank of a municipal sewage treatment plant, a sludge retention time (SRT) is 6-20 days, and pH is controlled to be 9-10; according to SRT, an excess sludge fermentation mixture is discharged to a fermentation mixture storage tank every day and an equal volume of fresh excess sludge is added to the excess sludge fermentation tank;
(2) start-up of sequencing batch reactor SBR
a complete nitrification sludge is used as inoculation sludge to be injected into the sequencing batch reactor SBR, and actual municipal sewage is used as raw water to be injected into a sewage tank and pumped into the sequencing batch reactor SBR through the third peristaltic pump, and meanwhile the sludge fermentation mixture is pumped into the sequencing batch reactor SBR through the second peristaltic pump, and it runs for 2˜4 cycles every day, a drainage ratio is maintained at 50˜80%, and each cycle includes influent, anaerobic stirring, aeration, anoxic stirring, settle and drainage;
sequencing batch reactor SBR:
I. influent: an amount for sewage feeding is set at ½˜⅘ of SBR effective volume, and an amount for the fermentation mixture feeding is 1/50˜ 1/10 of the sewage feeding volume, both are controlled by a time-controlled switch, after SBR is started, the sewage in the sewage tank is allowed to enter the sequencing batch reactor SBR through the third peristaltic pump, during the sewage feeding, the fermentation mixture in the excess sludge fermentation tank is allowed to enter SBR through the second peristaltic pump;
II. anaerobic stirring: after completion of the influent, it enters a stage of anaerobic stirring, and a stirring time is set for 2˜3.5 h;
III. aeration: an air compressor is started to provide oxygen to the sequencing batch reactor SBR and ammonia-nitrogen is converted into oxidized nitrogen; dissolved oxygen DO of 0.5˜1 mg/L is maintained by a real-time control device, an aeration time is set for 1˜3 h, and when a mass concentration ratio of NO₂⁻—N to NH₄ ⁺—N is 1.5˜2.0, the aeration is stopped;
IV. anoxic stirring: anoxic stirring time is set for 2˜5 h;
VI. settle and drainage: a sedimentation time for settle is set for 1˜2 h, the drainage is performed after a separation of sludge and water, wherein a drainage ratio is 50%-80%.
